(19) United States
(12) Patent Application Publication
(10) Pub. No.: US 2008/0074213 A1
(43) Pub. Date: Mar. 27, 2008

(54) FILTER

(75) Inventors: Hsin-Ping Chen, Tu-Cheng (TW); Kuang-Wei Cheng, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,881

(22) Filed: Dec. 28, 2006

(30) Foreign Application Priority Data
Sep. 22, 2006 (CN) 200610062731.4

(51) Int. Cl. H01P 1/203

(52) U.S. Cl. 333/204

(57) ABSTRACT

A filter (20) includes an input part (200), an output part (202), a first portion (22), a second portion (24), and a third portion (26). The input part is for receiving electromagnetic signals, and the output part is for transmitting the electromagnetic signals. The first portion with high impedance is electronically connected to the input part and the output part. The second portion with low impedance is electronically connected to two ends of the first portion. The third portion partially surrounds the second portion, and is electro-magnetically coupled to the second portion.

### BACKGROUND OF THE INVENTION

1. Field of the Invention

The present invention generally relates to communication filters, and more particularly to a low-pass filter.

2. Description of Related Art

Filters, as a key element in wireless network products, are widely used. However, when a filter is working, second harmonic and even higher order harmonic wave noises will be generated due to the nonlinear distortion of power amplifiers in the wireless communication products without filters.

Referring to FIG. 5, a schematic diagram of a conventional filter 10 is shown. The filter 10 includes an input part 100, an output part 102, a high impedance line 12, and a low impedance line 14. The input part 100 for receiving electromagnetic signals and the output 102 for transmitting the electromagnetic signals are respectively electronically connected to the high impedance line 12. The low impedance line 14 includes a first coupling part 140 and a second coupling part 142. The first coupling part 140 and the second coupling part 142 are respectively electronically connected to two ends of the high impedance line 12.

Referring to FIG. 6, a diagram of simulated test results of the conventional filter 10 is shown. As shown, when the filter 10 operates at the working frequency of the IEEE 802.11a standard, only two transmission zeros are generated, which are ineffective to suppress the harmonic wave noises.

Therefore, a heretofore unaddressed need exists in the industry to overcome the aforementioned deficiencies and inadequacies.

### SUMMARY OF THE INVENTION

In one aspect of the embodiment, a filter includes an input part, an output part, a first portion, a second portion, and a third portion. The input part is for receiving electromagnetic signals, and the output part is for transmitting the electromagnetic signals. The first portion with high impedance is electronically connected to the input part and the output part. The second portion with low impedance is electronically connected to two ends of the first portion. The third portion partially surrounds the second portion, and is electro-magnetically coupled to the second portion.

In another aspect of the invention, a filter includes an input part, an output part, a first portion, a second portion, and a third portion. The input part is for receiving electromagnetic signals, and the output part is for transmitting the electromagnetic signals. The first portion is electronically connected to the input part and the output part. The second portion includes a first coupling part and a second coupling part. The first coupling part and the second coupling part are respectively electronically connected to two ends of the first portion, and the first coupling part is electro-magnetically coupled to the second coupling part. The third portion includes a first coupling line, a second coupling line, and a third coupling line. The second coupling line is electronically connected between the first coupling line and the third coupling line. The first coupling line, the second coupling line, and the third coupling line surround the second portion. The first coupling line is electro-magnetically coupled to the first coupling part, the second coupling line is electro-magnetically coupled to the first coupling part and the second coupling part, the third coupling line is electro-magnetically coupled to the second coupling part.

Other advantages and novel features will become more apparent from the following detailed description when taken in conjunction with the accompanying drawings, in which:

### BRIEF DESCRIPTION OF THE DRAWINGS

FIG. 1 is a schematic diagram of a filter according to an exemplary embodiment of the present invention;

FIG. 2 is a schematic diagram showing a coupling effect of the filter of FIG. 1;

FIG. 3 is a diagram of simulated test results of the filter according to an exemplary embodiment of the present invention;

FIG. 4 is a comparative diagram of the simulated test results of the conventional filter and the simulated test results of the filter of an exemplary embodiment of the present invention;

FIG. 5 is a schematic diagram of a conventional filter; and

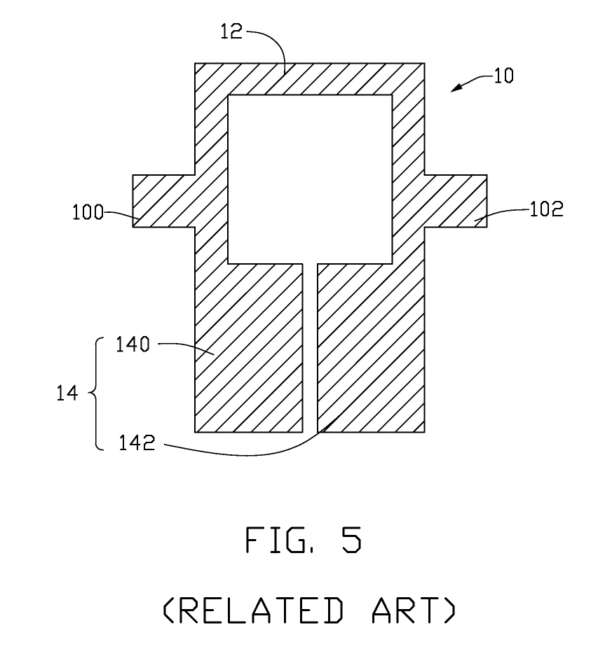

FIG. 6 is a diagram of simulated test results of the conventional filter.

### DETAILED DESCRIPTION OF THE INVENTION

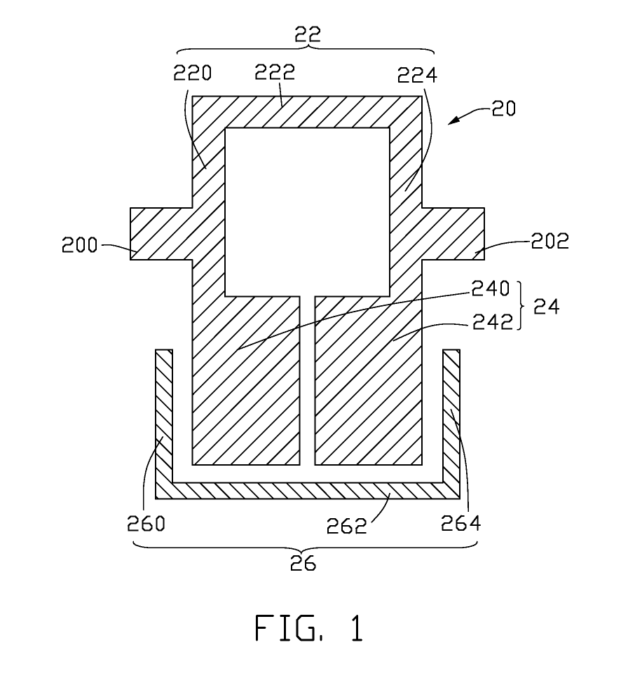

FIG. 1 is a schematic diagram of a filter 20 according to an exemplary embodiment of the present invention. The filter 20 is printed on a substrate (not shown), and includes an input part 200, an output part 202, a first portion 22, a second portion 24, and a third portion 26. In the exemplary embodiment, the filter 20 is a low-pass filter.

The input part 200 receives electromagnetic signals, and the output part 202 transmits the electromagnetic signals. The input part 200 and the output part 202 are aligned. In this embodiment, the input part 200 and the output part 202 are used for impedance matching of the filter 10 with an impedance value of approximately 50 ohms.

The first portion 22 with high impedance includes a first transmission line 220, a second transmission line 222, and a third transmission line 224. The second transmission line 222 is electronically connected between the first transmission line 220 and the third transmission line 224. In the exemplary embodiment, the first transmission line 220 and the third transmission line 224 are perpendicular to the second transmission line 222; that is, the first transmission line 220 is parallel to the third transmission line 224. The input part 200 is electronically connected to the first transmission line 220, and the output part 202 is electronically connected to the third transmission line 224.

The second portion 24 with low impedance includes a first coupling part 240 and a second coupling part 242. The first coupling part 240 and the second coupling part 242 are respectively electronically connected to two ends of the first portion 22; that is, the first coupling part 240 is electronically connected to one end of the first transmission line 220, and the second coupling part 242 is electronically connected to one end of the third transmission line 224. The first coupling part 240 is parallel to the second coupling part 242. Hereinafter, coupled will refer to electromagnetic coupling as from mutual inductance or stray capacitance known to those skilled in the art and familiar with filters. There is a clearance configured between the first coupling part 240 and the second coupling part 242, allowing the first coupling part 240 to be coupled with the second coupling part 242.

The third portion 26 partially surrounds the second portion 24, and there is a clearance configured between the second portion 24 and the third portion 26. In the exemplary embodiment, the third portion 26 includes a first coupling line 260, a second coupling line 262, and a third coupling line 264, and the second coupling line 262 is electronically connected between the first coupling line 260 and the third coupling line 264. The first coupling line 260 and the third coupling line 264 are perpendicular to the second coupling line 262; that is, the first coupling line 260 is parallel to the third coupling line 264.

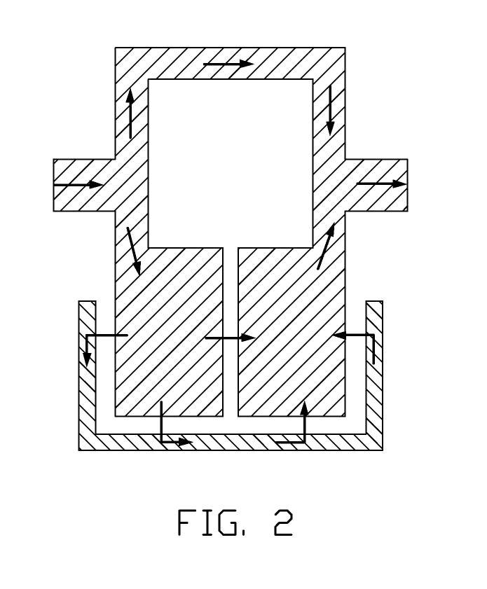

The first coupling line 260 is configured adjacent to but spaced from one side of the first coupling part 240, and is coupled to the first coupling part 240. The second coupling line 262 is configured adjacent to but spaced from another side of the first coupling part 240 and one side of the second coupling part 242, and is coupled to the first coupling part 240 and the second coupling part 242. The third coupling line 264 is configured adjacent to but spaced from another side of the second coupling part 242, and is coupled to the second coupling part 242. Referring also to FIG. 2, it is a schematic diagram showing a coupling effect of the filter 20 of FIG. 1.

In the exemplary embodiment, the first coupling part 240 and the second coupling part 242 are substantially rectangular shaped, and the first transmission line 220, the second transmission line 222, the third transmission line 224, the first coupling line 260, the second coupling line 262, and the third coupling line 264 are all substantially rectangular shaped strips. In other exemplary embodiments, the third portion 26 can be changed to other shapes, but must satisfy that the third portion 26 can be coupled to the second portion 24.

In the exemplary embodiment, a length and a width of the first transmission line 220 are respectively about 1.4 millimeter (mm) and 0.25 mm. A length and a width of the second transmission line 222 are respectively about 1.9 mm and 0.25 mm. A length and a width of the third transmission line 224 are respectively about 1.4 mm and 0.25 mm. A length and a width of the first coupling part 240 are respectively about 1.4 mm and 0.89 mm. A length and a width of the second coupling part 242 are respectively about 1.4 mm and 0.89 mm. A length and a width of the first coupling line 260 are respectively about 1.02 mm and 0.125 mm. A length and a width of the second coupling line 262 are respectively about 2.41 mm and 0.125 mm. A length and a width of the third coupling line 264 are respectively about 1.02 mm and 0.125 mm. The clearance between the first coupling part 240 and the second coupling part 242 and the clearance between the second portion 24 and the third portion 26 are both about 0.125 mm.

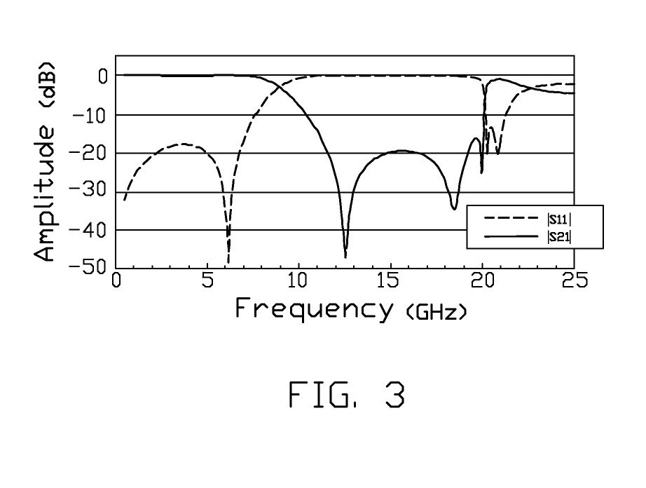

FIG. 3 is a diagram of simulated test results showing a relationship between filtration and reflection coefficient and frequency of electromagnetic signals traveling through the filter 20. The horizontal axis represents the frequency in gigahertz (GHz) of the electromagnetic signals traveling through the filter 20, and the vertical axis represents the filtration and reflection coefficient in decibels (dB) of the filter 20. The curve |S21| represents the transmission coefficient indicating a relationship between input power and output power of the electromagnetic signals traveling through the filter 20, and the transmission coefficient is calculated by the following equation:

Transmission coefficient (dB)=10*log[|S21|]=10*Log[(Output Power)/(Input Power)], when port 2 is terminated in matched loads

When electromagnetic signals travel through the filter 20, a part of the input power of the electromagnetic signals is returned to a source of the electromagnetic signals. The part of the input power returned to the source of the electromagnetic signals is called return power. The curve |S11| represents the reflection coefficient indicating a relationship between the input power and the return power of the electromagnetic signals traveling through the filter 20, and the reflection coefficient is calculated by the following equation:

Reflection coefficient (dB)=10*log[|S11|]=10*Log[(Return Power)/(Input Power)], when port 2 is terminated in matched loads

For a filter, when the output power of the electromagnetic signals in a pass band frequency range is close to the input power of the electromagnetic signals, and the return power of the electromagnetic signals is small, it means that a distortion of the electromagnetic signals is small and the performance of the filter is good. That is, the smaller the absolute value of the transmission coefficient of the electromagnetic signals is, and the bigger the absolute value of the reflection coefficient of the electromagnetic signals is, the better the performance of the filter is.

As shown in FIG. 3, the filter 20 operating at working frequency of the IEEE 802.11a standard has good performance. As indicated by the curve |S21|, the absolute value of the transmission coefficient of the electromagnetic signals in the pass band frequency range is close to 0. As indicated by the curve |S11|, the absolute value of the reflection coefficient of the electromagnetic signals in the pass band frequency range is greater than 10, and the absolute value of the reflection coefficient of the electromagnetic signals beyond the pass band frequency range is less than 10.

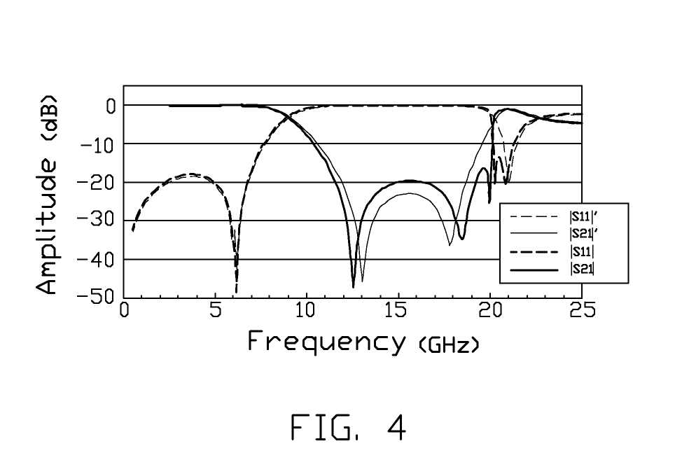

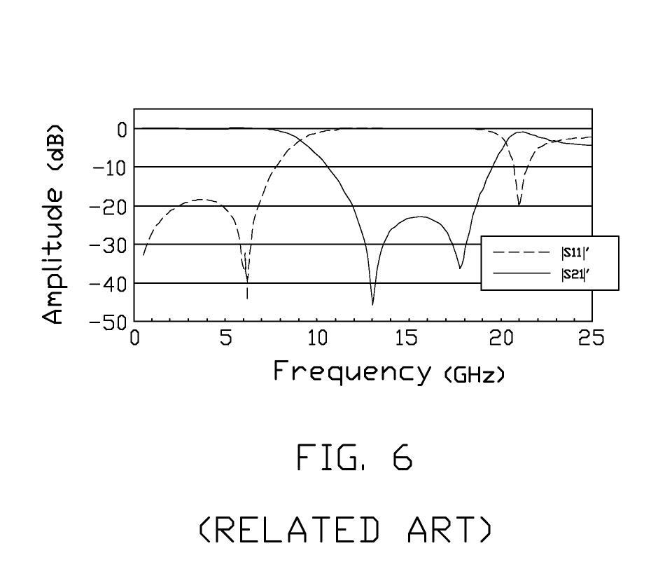

FIG. 4 is a comparative diagram of the simulated test results of the conventional filter 10 and the simulated test results of the filter 20 of an exemplary embodiment of the present invention. The curves |S11|′ and |S21|′ of FIG. 4 are the same as the curves |S11|′ and |S21|′ of FIG. 6, and the curves |S11| and |S21| of FIG. 4 are the same as the curves |S11| and |S21| of FIG. 3. As shown in FIG. 4, an attenuation rate of the filter 20 is bigger than an attenuation rate of the conventional filter 10, and the present filter 20 generates another transmission zero.

In the exemplary embodiment, the filter 20 uses the third portion 26 surrounding and coupled to the second portion 24 to increase total coupling, and an extra impedance converter can be eliminated in the present invention.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A filter, comprising:
an input part, for receiving electromagnetic signals;
an output part, for transmitting the electromagnetic signals;
a first portion with high impedance electronically connected to the input part and the output part;
a second portion with low impedance electronically connected to two ends of the first portion; and
a third portion electro-magnetically coupled to the second portion, and partially surrounding the second portion.

2. The filter of claim 1, wherein the input part and the output part are used for impedance matching of the filter, with an impedance value of substantially 50 ohms.

3. The filter of claim 1, wherein the input part and the output part are aligned.

4. The filter of claim 1, wherein a clearance is configured between the second portion and the third portion.

5. The filter of claim 4, wherein the third portion comprises a first coupling line, a second coupling line, and a third coupling line, and the second coupling line is electronically connected between the first coupling line and the third coupling line.

6. The filter of claim 5, wherein the first coupling line and the third coupling line are perpendicular to the second coupling line.

7. The filter of claim 5, wherein the second portion comprises a first coupling part and a second coupling part, respectively connected to the two ends of the first portion, a clearance is configured between the first coupling part and the second coupling part so that the first coupling part is electro-magnetically coupled to the second coupling part.

8. The filter of claim 7, wherein the first portion comprises a first transmission line, a second transmission line, and a third transmission line, and the second transmission line is electronically connected between the first transmission line and the third transmission line.

9. The filter of claim 8, wherein the input part is electronically connected to the first transmission line, and the output part is electronically connected to the third transmission line.

10. The filter of claim 8, wherein the first coupling part is electronically connected to the first transmission line, and the second coupling part is electronically connected to the third transmission line.

11. A filter, comprising:
an input part, for receiving electromagnetic signals;
an output part, for transmitting the electromagnetic signals;
a first portion electronically connected to the input part and the output part;
a second portion, comprising a first coupling part and a second coupling part, respectively electronically connected to two ends of the first portion, and the first coupling part electro-magnetically coupled to the second coupling part; and
a third portion, comprising a first coupling line, a second coupling line, and a third coupling line, and the second coupling line electronically connected between the first coupling line and the third coupling line;
wherein the first coupling line, the second coupling line, and the third coupling line surround the second portion, and the first coupling line is electro-magnetically coupled to the first coupling part, the second coupling line is electro-magnetically coupled to the first coupling part and the second coupling part, the third coupling line is electro-magnetically coupled to the second coupling part.

12. The filter of claim 11, wherein the input part and the output part are aligned.

13. The filter of claim 11, wherein the first coupling part is parallel to the second coupling part, a clearance is configured between the first coupling part and the second coupling part so that the first coupling part is coupled to the second coupling part.

14. The filter of claim 13, wherein a clearance is configured between the second portion and the third portion so that the second portion is coupled to the third portion.

15. The filter of claim 11, wherein the first coupling line and the third coupling line are perpendicular to the second coupling line.

16. The filter of claim 11, wherein the first portion comprises a first transmission line, a second transmission line, and a third transmission line, and the second transmission line is electronically connected between the first transmission line and the third transmission line.

17. The filter of claim 16, wherein the input part is electronically connected to the first transmission line, and the output part is electronically connected to the third transmission line.

18. The filter of claim 16, wherein the first coupling part is electronically connected to the first transmission line, and the second coupling part is electronically connected to the third transmission line.
